(19) United States
(12) Patent Application Publication
(10) Pub. No.: US 2026/0122264 A1
(43) Pub. Date: Apr. 30, 2026

(54) Video Encoding Parameter Design Support Device and Video Encoding Parameter Design Support Method

(71) Applicant: Hitachi, Ltd., Tokyo (JP)

(72) Inventor: Hiromu KAMEI, Tokyo (JP)

(21) Appl. No.: 19/194,618

(22) Filed: Apr. 30, 2025

(30) Foreign Application Priority Data
Oct. 31, 2024 (JP) 2024-192341

(51) Int. Cl. H04N 19/463; H04N 19/154; H04N 19/172; H04N 19/88

(52) U.S. Cl. CPC H04N 19/463; H04N 19/154; H04N 19/172; H04N 19/88

(57) ABSTRACT

The present invention provides a technique capable of preferably automatically designing a video encoding parameter given to a hardware video encoder.

The invention discloses a method for automatically designing video encoding parameters for a hardware video encoder. A design support device-implemented on a computer with a processor and memory-generates one or more shifted originals by advancing or delaying an original video by a set number of frames via a preprocessing unit. A video quality calculation unit then aligns frames between a set comprising the encoded video and the original video and another set comprising the encoded video and the shifted original video by matching process start positions. It calculates a similarity for each corresponding frame pair, and the highest similarity value for each frame for encoded video is designated as the video quality evaluation value.

### BACKGROUND

The present invention relates to a technique, at the time of performing an encoding process on an uncompressed video, for preferably designing a parameter for controlling compression ratio or the like of the video (hereinafter, also called “video encoding parameter”).

In recent years, with backgrounds of declining birthrate and aging population and the COVID-19 epidemic, a remote-operation-type application capable of eliminating physical restrictions related to working places such as robot control or video edition by a remote operation, provision of medical service from a remote place, and the like is being spread. To realize the remote-operation-type application, information transfer means capable of bidirectionally transferring data expressing various information at sufficiently high speed is essential. A video is one of main transfer targets for such information transfer means in many use cases.

Generally, an uncompressed video has a very large data amount. It is difficult to transfer a video as it is via a network. At the time of realizing a remote-operation-type application utilizing videos, in many cases, a device of compressing a video called a video encoder is used, an encoding process is performed on an uncompressed video in advance to compress the video so that the data amount becomes smoothly transferable, and the compressed video is transmitted.

When the value of a video encoding parameter given to the video encoder is inappropriate in the relation with a requirement to make the remote-operation-type application comfortably operate (hereinafter, also called “application requirement”), by performing the encoding process, a case often occurs such that a part of the information included in the video drops unexpectedly, and the quality of the video deteriorates unintendedly. In a remote-operation-type application utilizing videos, in the case where unintended deterioration occurs in the quality of the video, there is a risk causing decrease in efficiency of communication among users performed via a network, decrease in safety, and the like. It is consequently necessary to preferably design a video encoding parameter in accordance with an application requirement.

Under such a background, for example, a technique of setting video encoding parameters of various values, performing an encoding process on an uncompressed video, and deriving the relationship between a required communication volume and video quality for each of the values of the video encoding parameters (for example, G. J. Sullivan and T. Wiegand, “Rate-distortion optimization for video compression,” in IEEE Signal Processing Magazine, vol. 15, no. 6, pp.74-90, Nov. 1998) and the like are known.

Moreover, for example, a technique of setting video encoding parameters of different values in various user environments, performing an encoding process on an original video, evaluating the video quality of each of the videos subjected to the encoding process (hereinafter, also called “encoded video”) in accordance with ITU-TJ.247 (for example, Japanese Patent No. 5215981) and the like are known.

### SUMMARY

In the technique disclosed in G. J. Sullivan and T. Wiegand, “Rate-distortion optimization for video compression,” in IEEE Signal Processing Magazine, vol. 15, no. 6, pp. 74-90, Nov. 1998, an uncompressed video and an encoded video are mechanically compared by a method of digitalizing the difference between the two videos pixel by pixel, and on the basis of the comparison result, drawing a non-linear graph expressing the relation between a required communication volume and a video distortion as one of video quality evaluation indexes for each of values of video encoding parameter values given to the video encoder, thereby evaluating the quality of the video in association with a quality which can be perceived by a human. To accurately evaluate the quality of a video by this method, at the time of comparing an uncompressed video and an encoded video, corresponding frames have to be compared sequentially from the head one frame by one frame. With respect to this point, in the case of using a hardware video encoder for the encoding process, an error such as copying or missing occurs at high frequency in a part of video frames due to a clock error in relation to another device connected in front of or behind the hardware video encoder. Consequently, in an attempt to design a video encoding parameter by using the technique disclosed in G. J. Sullivan and T. Wiegand, “Rate-distortion optimization for video compression,” in IEEE Signal Processing Magazine, vol. 15, no. 6, pp. 74-90, Nov. 1998, in the case where the video encoder used for the encoding process is a hardware video encoder, at the time of comparing an uncompressed video and an encoded video, the same frames cannot be compared with certainty, and there is a problem that it is difficult to accurately evaluate the quality of the video.

According to the technique described in Japanese U.S. Pat. No. 5,215,981, the quality of each encoded video is evaluated by a human. Consequently, at the time of designing a video encoding parameter by using the technique disclosed in Japanese U.S. Pat. No. 5,215,981, in many cases, there is a problem that realization possibility is low since enormous human resources are necessary to evaluate the video quality.

The present invention has been achieved in consideration of the above-described problems and an object is to provide a technique capable of automatically and preferably designing a video encoding parameter which is given to a hardware video encoder.

A video encoding parameter design support device according to the present invention is a device for supporting designing of a parameter of a video encoder, and is made by a computer including at least a processor and a memory. The processor creates one or more shifted original videos obtained by shifting an original video backward or forward by a predetermined number of frames by a video preprocess unit and, by a video quality calculation unit, makes videos in each set correspond to each other on a frame unit basis by aligning process start positions with respect to each of a set of an encoded video obtained by encoding the original video and the original video and a set of the encoded video and the shifted original video, calculates an index based on similarity of a set with respect to each of a set of a frame in the encoded video and a corresponding frame in the original video and a set of a frame in the encoded video and a corresponding frame in the shifted original video, and sets the largest one in the indexes calculated with respect to each of the frames in the encoded video as a video quality evaluation value of the frame.

According to the present invention, a video encoding parameter given to a hardware video encoder can be automatically preferably designed.

The challenge disclosed by the application and its solving method will become apparent by the column of the modes for carrying out the present invention and the drawings.

### BRIEF DESCRIPTION OF THE DRAWINGS

FIG. 1 is a diagram illustrating an example of a hardware configuration of a video encoding parameter design support device according to an embodiment.

FIG. 2 is a diagram illustrating an example of functional blocks of the video encoding parameter design support device according to the embodiment.

FIG. 3 is a diagram illustrating an example of a whole configuration of a video processing system including the video encoding parameter design support device according to the embodiment, together with the flow of various data processes executed by the video encoding parameter design support device.

FIG. 4 is a diagram for explaining a method of calculating a video quality evaluation value.

FIG. 5 is a sequence diagram illustrating an example of the flow of an entire video encoding parameter designing process.

FIG. 6 is a flowchart illustrating an example of the flow of a video quality evaluation value calculating process.

FIG. 7 is a flowchart illustrating an example of the flow of a video encoding parameter determining process.

FIG. 8 is a diagram illustrating an example of a GUI display screen (video encoding parameter determination support screen) in the video encoding parameter determining process.

### DETAILED DESCRIPTION

Embodiments of the present invention will hereinafter be described referring to drawings in detail. The present invention is not limited to the description of the following embodiments and modifications. An example of modifying a concrete configuration without departing from the idea and gist of the present invention is also included. For example, the following embodiments are for describing the present invention in detail. The present invention is not always limited to the embodiment having all of the components included in the description.

In the configuration of the invention which will be described hereinafter, the same reference numeral may be used to the same part and/or the same element or a part and/or an element having a similar function commonly in different drawings, and repetitive description may not be given.

In the case where there are a plurality of the same parts and/or the same elements or parts and/or elements having similar functions, description may be given by adding different suffixes to the same reference numeral. On the other hand, in the case where it is unnecessary to distinguish the plurality of parts and/or elements, description may be given without adding suffixes.

Notations such as “first”, “second”, and “third” in the specification and the like are used only to identify components and do not always limit to the number, order, its content, or the like. A character or a number for identifying a component is used in each context. A character or number used in a context does not always express the same configuration in another context. A component identified by a character or number is not prevented from also having a function of a component identified by another character or number.

The position, size, shape, range, and the like of each of components indicated in the specification and/or the drawings may not express the actual position, size, shape, range, and the like in order to facilitate understanding of the invention. Consequently, the present invention is not always limited to the positions, the sizes, the shapes, the ranges, and the like disclosed in the specification and/or the drawings.

Unless otherwise clearly described in a context, a component expressed in a singular form in the specification includes a plural form.

In the following description, “an interface device” may be one or more interface devices. The one or more interface devices may be at least one of the following devices.

One or more input/output interface devices

An input/output interface device is an interface device for at least one of an I/O (Input/Output) device and a remote computer for display. An input/output interface device for a computer for display may be a communication interface device. At least one I/O device may be any of a user interface device, for example, an input interface device such as a keyboard and a pointing device, and an output interface device such as a display device.

One or more communication interface devices

One or more communication interface devices may be one or more communication interface devices of the same kind (for example, one or more NICs (Network Interface Cards), or two or more communication interface devices of different kinds (for example, an NIC and an HBA (Host Bus Adapter) ). As a network accessed by a communication interface device at the time of communication, the Internet, a LAN (Local Area Network), a WAN (Wide Area Network), a cellular phone network, or the like can be assumed, but the invention is not limited to them.

In the following description, a “storage device” includes at least one or more memory devices (hereinafter, also called “memory”) as a main storage device. This memory may be a volatile memory device (hereinafter, also called “volatile memory”) or a nonvolatile memory device (hereinafter, also called “nonvolatile memory”). The storage device may include, in addition to one or more memories, one or more PDEVs (Physical storage DEVices) as an auxiliary storage device. The PDEV is typically a nonvolatile storage device (for example, a persistent storage device) and may be various kinds of storage devices (hereinafter, also called “storages”) such as, concretely, for example, an HDD (Hard Disk Drive), an SSD (Solid State Drive), an NVME (Non-Volatile Memory Express) drive, or an SCM (Storage Class Memory).

That is, in the following description, a “storage device” may be at least a memory including a memory as a main storage device and a storage as an auxiliary storage device.

In the following description, a “processor” as a computation device is one or more processor devices. At least one processor device is typically a microprocessor device such as a CPU (Central Processing Unit) but may include a processor device of another kind such as a GPU (Graphics Processing Unit), an MPU (Micro Processing Unit), or a DSP (Digital Signal Processor). At least one processor device may be a single core or a multicore. At least one processor device may be a processor core. At least one processor device may be a processor device in a broad sense such as a hardware circuit ( for example, FPGA (Field Programmable Gate Array), CPLD (Complex Programmable Logic Device), or ASIC (Application Specific Integrated Circuit)) performing a part or all of the process, or may include such a processor device in a broad sense.

In the following description, a function may be described by an expression of “xxx unit”. A function may be realized when one or more computer programs (hereinafter, also simply called “program”) are executed by a processor, may be realized by one or more hardware circuits (for example, FPGA or ASIC), or may be realized by a combination of them. In the case where a function is realized when a program is executed by a processor, a predetermined process is performed properly using a storage device and/or an interface device or the like, so that the function may be set as at least a part of the processor. A process described by using a function as the subject may be a process performed by a processor (or a device such as a controller having the processor). A program may be installed from a program source. A program source may be, for example, a program distribution computer or a computer-readable recording medium (for example, a non-transitory recording medium). The description of each of the functions is an example. A plurality of functions may be collected in a single function a single function may be divided into a plurality of functions.

In the following description, there is a case of describing a process using a “program” as a subject. When a program is executed by a processor, the program performs a predetermined process by properly using a storage device and/or an interface device or the like. Consequently, the subject of the process may be a processor (or a device such as a controller having the processor). A program may be installed from a program source to a device such as a computer. A program source may be, for example, a program distribution server or a computer-readable (for example, non-transitory) recording medium. In the following description, two or more programs may be realized as a single program. A single program may be realized by two or more programs.

In the following description, a “data set” refers to data made of one or more data elements (a block of logical electrical data) and may be, for example, any of a record, a file, a key-value pair, and a tuple.

In the following description, a “video encoding parameter design support device” may be a device configured by one or more physical computers (for example, an on-premise device). “Displaying” of information for display by the video encoding parameter design support device may be displaying of information for display on a display device of a computer (the video encoding parameter design support device) or transmission of information for display to a computer for display from the computer (video encoding parameter design support device) (in the latter case, the information for display is displayed by the computer for display).

### Configuration Example of System

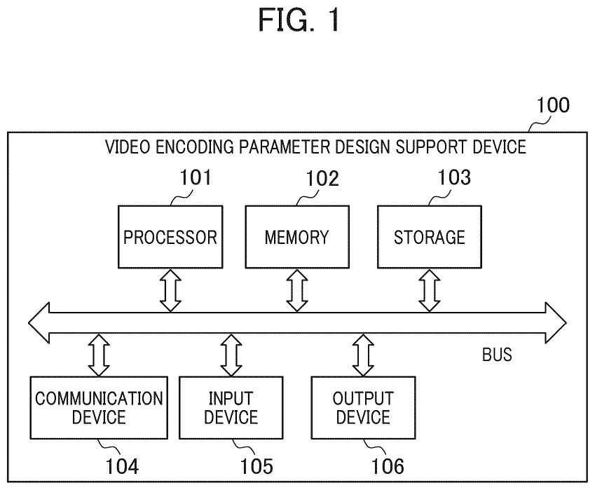

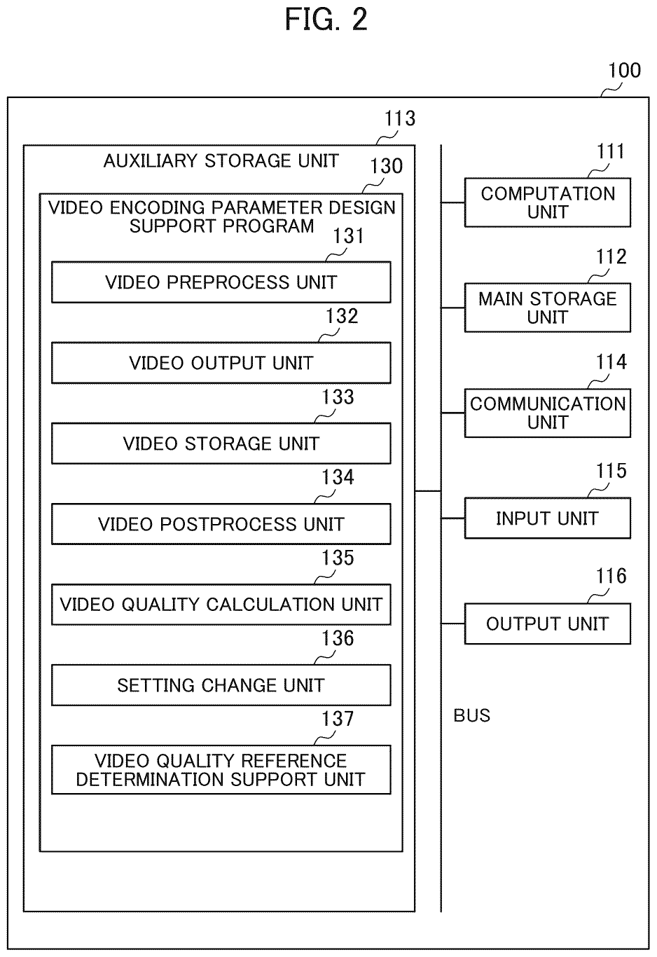

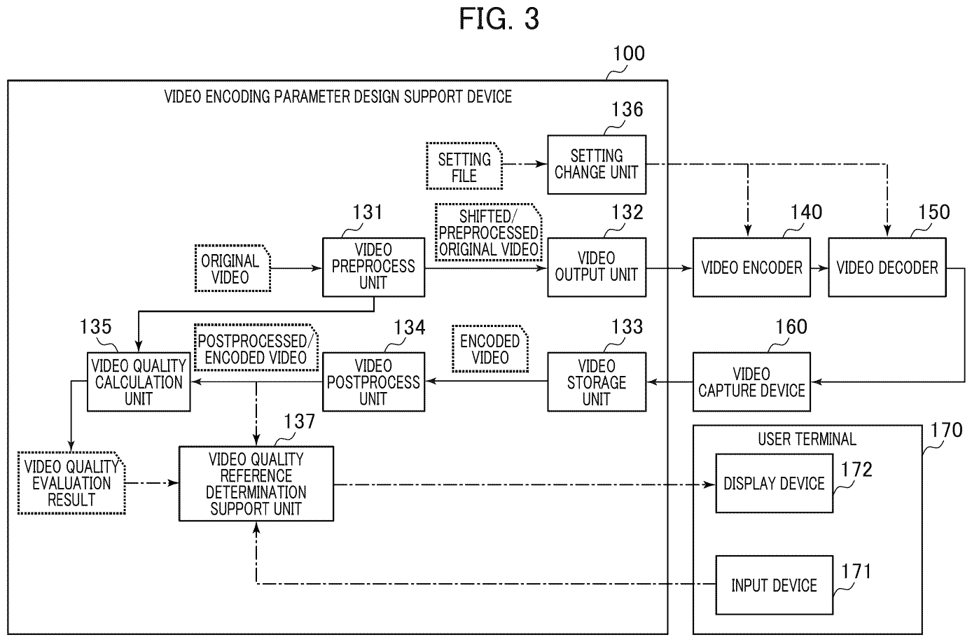

First, a configuration example of a video encoding parameter design support device 100 according to a present embodiment will be described with reference to FIGS. 1 to 3. FIG. 1 is a diagram illustrating an example of the hardware configuration of the video encoding parameter design support device 100. FIG. 2 is a diagram illustrating an example of functional blocks of the video encoding parameter design support device 100. FIG. 3 is a diagram illustrating an example of the configuration of an entire video processing system including the video encoding parameter design support device 100 together with the flow of various data processes executed by the video encoding parameter design support device 100.

### Configuration Example of Entire System

The video encoding parameter design support device 100 of the present embodiment is, broadly, a computer system capable of supporting designing of a parameter at the time of encoding a video, and is realized by a computer, a server, a control board, and the like having configurations which will be described later. The video encoding parameter design support device 100 is a general-purpose computer system configured on physically one computer or on a plurality of computers logically or physically configured, and may operate in different threads on the same computer or operate on a virtual computer configured on a plurality of physical computer resources. The present embodiment will be described on assumption that the video encoding parameter design support device 100 is configured by a single computer. The video encoding parameter design support device 100, however, may be configured by a plurality of computers and/or servers.

To the video encoding parameter design support device 100, as illustrated in FIG. 3, at least a video encoder 140 as a dedicated computer performing a process of compressing a video (hereinafter, also called “encoding process”) and a video capture device 160 as a dedicated computer performing a process of converting a video into a storable form are connected so as to be able of transmitting/receiving data mutually. The video encoder 140 and the video capture device 160 are connected so as to transmit/receive data to/from each other via a video decoder 150 as a dedicated computer performing a decoding process. Between the video encoding parameter design support device 100 and the video encoder 140, and between the video decoder 150 and the video capture device 160, wire connection is established by an HDMI (registered trademark) cable. They may be connected by another kind of a wired network such as an SDI (Serial Digital Interface) or a UTP (Unshielded Twisted Pair). Between the video encoder 140 and the video decoder 150, and between the video encoding parameter design support device 100 and the video encoder 140 and the video decoder 150, wire connection is established by a UTP (Unshielded Twisted Pair) cable, an optical fiber cable, or the like. They may be also connected wirelessly by Wi-Fi (registered trademark), LTE (registered trademark), 4G, 5G, or the like. The video capture device 160 and the video encoding parameter design support device 100 are connected via a USB (Universal Serial Bus) cable. Between those devices, various interface converters such as an HDMI-SDI converter and an SDI-HDMI converter may be interposed.

That is, the video encoding parameter design support device 100, the video encoder 140, the video decoder 150, and the video capture device 160 are connected so as to be able to transmit/receive data mutually via various communication networks (hereinafter, also simply called “network”) as described above, thereby configuring, as a whole, the video processing system illustrated in FIG. 3. A video is transmitted among those computers (100, 140, 150, and 160) by using a proper communication protocol such as, for example, the IP (Internet Protocol), the UDP (User Datagram Protocol), the TCP (Transmission Control Protocol), or the RTP (Real-time Transport Protocol).

In the video processing system of the present embodiment illustrated in FIG. 3, a video output from the video encoding parameter design support device 100 is transmitted first to the video encoder 140 and subjected to the encoding process. Then, the resultant video is transmitted to the video decoder 150 and is subjected to the decoding process. Further, the video is transmitted to the video capture device 160 and is converted to a storable form. After that, the video is transmitted again to the video encoding parameter design support device 100 and stored in the video encoding parameter design support device 100. The video encoding parameter design support device 100 calculates an evaluation value regarding the quality of the video (hereinafter, also called a “video quality evaluation value”) by using the video (hereinafter, also called “encoded video”) stored through the series of the flow (the details will be described later).

The video encoding parameter design support device 100, the video encoder 140, the video decoder 150, and the video capture device 160 do not share a clock, so that an error may occur in timings of the video processes.

Consequently, for example, by processing a video which is to be processed at 30 FPS (Frame Per Second) at 30.0001 FPS or the like, copying of a frame occurs during the process. On the contrary, by processing the video at 29. 9999 FPS, missing of a frame occurs. In practice, clocks fluctuate, so that copying and missing mixedly exist in one video.

To the video encoding parameter design support device 100, as illustrated in FIG. 3, various user terminals 170 such as a laptop PC, a tablet, a smartphone, and the like, each including an input device 171 and a display device 172 held by the user of the video processing system are connected so as to be able to transmit/receive data mutually via a network. The input device 171 is, for example, any of various input interface devices for receiving an input operation from the user of the video processing system, such as a keyboard, a pointing device, a touch panel, or the like. The display device 172 is, for example, any of various output interface devices for outputting a process result in a visible form to the user of the video processing system, such as a liquid crystal display, a touch screen, or the like. The present embodiment will be described on assumption that the input device 171 and the display device 172 are integrally operated in the same terminal so as to execute an input function and an output function, respectively. Alternatively, the input device 171 and the display device 172 may be realized, for example, as separate terminals.

Each of the input devices 171 and/or each of the display devices 172 and the network are connected wirelessly but may be connected by a wire.

To the video encoding parameter design support device 100, for example, further another apparatus, device, terminal or the like (hereinafter, also simply called “another device”) such as a distribution server for distributing videos, various data servers, or the like may be connected data-communicably via a network. In this case, another device and the network may be connected by a wire via a known communication device (not illustrated) or connected wirelessly. In this case, the video encoding parameter design support device 100 may obtain, for example, various data used for processes which will be described later from such another device.

The present embodiment has been described on assumption that the video encoding parameter design support device 100 is configured by a single computer as illustrated in FIGS. 1 to 3. The video encoding parameter design support device 100, however, may be configured by, for example, a plurality of computers.

The present embodiment has been described on assumption that the video encoding parameter design support device 100, and various apparatuses, devices, terminals, and the like (hereinafter, they may be collectively called “external devices”) which are connected to the video encoding parameter design support device 100 so as to be able to transmit/receive data mutually such as the video encoder 140, the video decoder 150, the video capture device 160, the user terminal 170, another device, and the like are separate devices. However, the video encoding parameter design support device 100 and the external devices may be configured, for example, by the same device. In this case, the video encoding parameter design support device may be configured, for example, as a system including the external devices. For example, the video encoding parameter design support device may be configured in a form including a part or all of the functions of the external devices.

### Hardware Configuration Example of Video Encoding Parameter Design Support Device 100

Subsequently, an example of the hardware configuration of the video encoding parameter design support device 100 will be described with reference to FIG. 1.

The video encoding parameter design support device 100 according to the present embodiment is realized by a computer having at least a storage device including a memory 102 as a main storage device and a storage 103 as an auxiliary storage device, an interface device including at least a communication device 104, and a processor 101 as an arithmetic device connected to those devices. In the video encoding parameter design support device 100, the interface device may include an input device 105 and/or an output device 106.

In the following description, it is assumed that the video encoding parameter design support device 100 is realized by one general-purpose computer having one or more processors 101, one or more memories 102, one or more storages 103, one or more communication devices 104, one or more input devices 105, one or more output devices 106, and a wired or wireless bus connecting the components.

The storage 103 as an auxiliary storage device is an auxiliary storage device made by a nonvolatile storage element such as a flash memory. Concrete examples of the storage 103 are various storages such as an SSD (Solid State Drive) and an HDD (Hard Disk Drive). The storage 103 stores at least a video encoding parameter design support program 130. The video encoding parameter design support program 130 is a computer program for equipping necessary functions as the video encoding parameter design Support device 100.

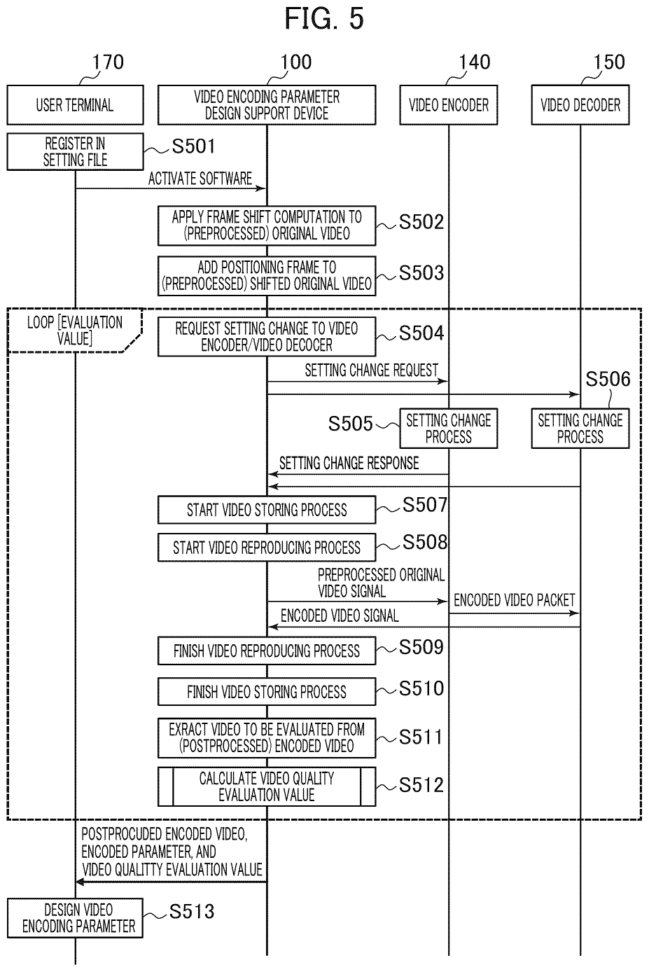

That is, when the video encoding parameter design support program 130 is executed by the processor 101, functions of function units of the video encoding parameter design support device 100 such as a video preprocess unit 131, a video output unit 132, a video storage unit 133, a video postprocess unit 134, and a video quality calculation unit 135 are realized. In other words, when the video encoding parameter design support program 130 is executed by the processor 101, various processes which will be described later with reference to FIGS. 5 to 7 are performed.

The video encoding parameter design support program 130 is provided for the video encoding parameter design support device 100 via the network and stored in the storage 103 as a non-transitory storage medium.

The video encoding parameter design support program 130 may be installed from a program source. The program source may be, for example, a program distribution computer, a computer-readable recording medium, or the like. The video encoding parameter design support program 130 may be configured by a device driver, an operating system, various application programs positioned in upper layers of them, or a library providing a common function to those programs. Further, two or more programs may be realized as one video encoding parameter design support program 130, or one video encoding parameter design support program 130 may be realized as two or more programs.

The memory 102 as a main storage device is a main storage device mainly made by a volatile storage element such as a RAM (Random Access Memory). The memory 102 includes a ROM (Read Only Memory) made by a nonvolatile storage element. In the ROM, an immutable program (for example, a BIOS) or the like is stored. In the memory 102, data expressing various information read from the storage 103 and various data obtained via the communication device 104 and/or the input device 105 is temporarily retained.

The processor 101 as a computation device is a processor device such as a CPU (Central Processing Unit) and various co-processors. By loading the various computer programs including the video encoding parameter design support program 130 in the memory 102 and executing them, the processor 101 performs overall control on the video encoding parameter design support device 100 itself and controls a computation unit 111 performing various processes such as computation, determination, and control.

The interface device includes the communication device 104 controlling a communication unit 114 which will be described later, the input device 105 controlling an input unit 115 which will be described later, and the output device 106 controlling an output unit 116 which will be described later.

The communication device 104 is, for example, various network interface devices for controlling communication with other apparatuses, devices, terminals, and the like such as the video encoder 140, the video decoder 150, and the video capture device 160 in conformity with a predetermined protocol.

The input device 105 is, for example, various input interface devices for receiving an input operation by a user, an operator, or the like of the video encoding parameter design support device 100, such as a touch panel, a keyboard, a mouse, a controller, and the like.

The output device 106 is, for example, various output interface devices including a display device such as a liquid crystal display or a touch screen, for outputting a process result of the video encoding parameter design support program 130 in a recognizable form to the user, operator, or the like of the video encoding parameter design support device 100.

The video encoding parameter design support device 100 may be realized by an independent device or an assembled device.

### Example of Functional Blocks of Video Encoding Parameter Design Support Device 100

An example of blocks of various functions of the video encoding parameter design support device 100 according to the present embodiment will now be described with reference to FIG. 2. Each of blocks described hereinafter is not a configuration in a hardware unit but is a block in a function unit.

The video encoding parameter design support device 100 is configured by functional blocks of the computation unit 111 realized mainly by the above-described processor 101, a main storage unit 112 realized by the above-described memory 102, an auxiliary storage unit 113 realized by the above-described storage 103, the communication unit 114 realized by the above-described communication device 104, and a user interface unit including the input unit 115 realized by the above-described input device 105 and the output unit 116 realized by the above-described output device 106. In the following description, in some cases, the main storage unit 112 and the auxiliary storage unit 113 will be collectively called a storage unit (112, 113).

The computation unit 111 executes various data processes on the basis of a program and data stored in the storage unit (112, 113) and data obtained by the communication unit 114. The computation unit 111 functions also as an interface of the storage unit (112, 113) and the communication unit 114.

The computation unit 111 has at least the function blocks of the video preprocess unit 131, the video output unit 132, the video storage unit 133, the video postprocess unit 134, and the video quality calculation unit 135 by executing the above-described video encoding parameter design support program 130 by the processor 101.

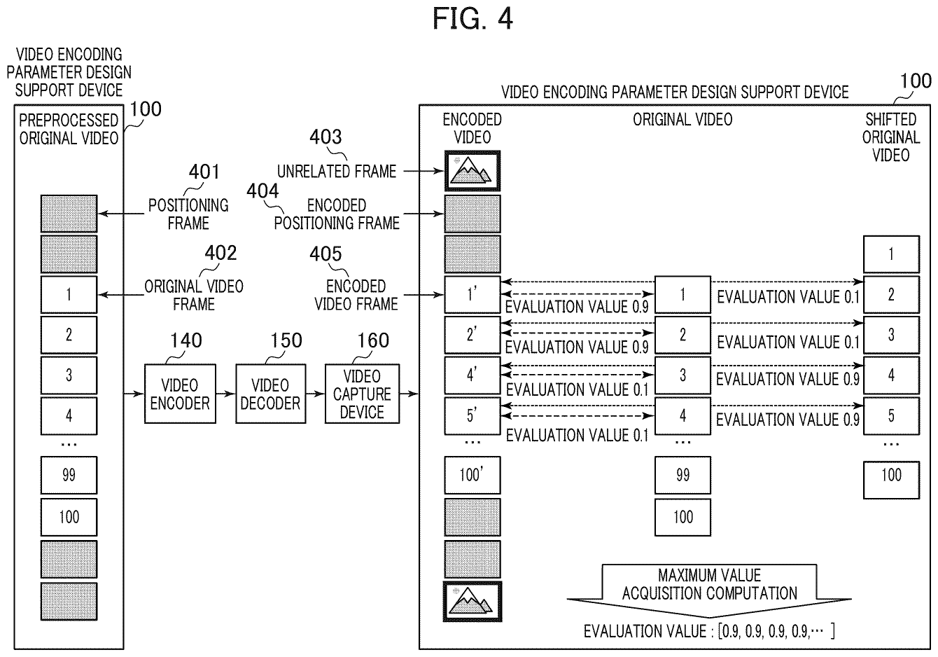

The video preprocess unit 131 executes, as preprocesses performed on a video, at least a process of creating a video obtained by adding positioning frames for specifying the start position and the end position of the video to the original video to be evaluated (hereinafter, also called “preprocessed original video”), and a process of creating a video obtained by shifting the original video backward or forward only by a predetermined number of frames (hereinafter, also called “shifted original video”) (the details will be described later with reference to FIGS. 4 and 5). The positioning frames in the preprocessed original video are used to extract only a video part to be evaluated from the received encoded video. The positioning frames are frames sufficiently different from a start frame and an end frame in a video to be evaluated and output frames other than a part to be evaluated. As a concrete example of a positioning frame, a series of frames having a known pattern such as a monochromatic frame, a color bar, and the like. The shifted original video is a video used only for video quality evaluation in which missing and copying of a frame is considered, and is created by shifting the original video backward or forward only by a predetermined number of frames. By using the shifted original video, also in an environment in which copying or missing of a frame occurs, at the time of comparing a frame in an encoded video and a frame in the original video, the same frames can be associated.

The video output unit 132 executes, at least, a process of outputting a preprocessed original video. The process is realized, for example, in a form of using a video player or the like. The video output unit 132 executes a process of notifying the video storage unit 133 of the end of output of the video and a process of outputting the video using a notification from the video storage unit 133 as a trigger. In such a manner, the video output unit 132 executes various processes related to output of a video.

The video storage unit 133 executes, at least, a process of storing an encoded video output from the video capture device 160.

The video storage unit 133 also executes a process of notifying the video output unit 132 of completion of preparation to store an encoded video and a process of completing storage of the encoded video received using a notification of the video output unit 132 as a trigger. In such a manner, the video storage unit 133 executes various processes related to storage of a video. The storage format of the encoded video is preferably the uncompressed format or lossless compression format from the viewpoint of prevention of degradation of the video quality (picture quality). However, in the case where the degree of degradation of the picture quality is sufficiently low, the video may be stored in the lossy compression format. Since it is difficult to control a video input timing for the hardware video encoder, all of videos which are input after cable connection are encoded and the resultant is output. Due to this, an encoded video stored by the video storage unit 133 may include, for example, a part other than the part to be evaluated such as a disk top screen of an OS (Operation System). Consequently, the computation unit 111 of the video encoding parameter design support device 100 has the video postprocess unit 134 performing a process of cutting out only a video part to be evaluated from the stored encoded video in order to perform proper video evaluation.

The video postprocess unit 134 executes, as a postprocess performed on a video, at least a process of creating a video obtained by extracting only a video part to be evaluated (hereinafter, also called “postprocessed encoded video”) by using the positioning frames from the encoded video stored in the video storage unit 133 (the details will be described with reference to FIG. 5).

The video quality calculation unit 135 executes, at least, a process of comparing the postprocessed encoded video and the original video and the shifted original video and calculating a video quality evaluation value on the basis of the comparison result (hereinafter, also called “video quality evaluation value calculating process”). In the video quality evaluation value calculating process, the video quality calculation unit 135 first compares the postprocessed encoded video and the original video and the shifted original vide obtained by shifting the video only by the predetermined number of frames, and calculates a video quality evaluation value for each of the frames of the postprocessed encoded video. After that, the video quality calculation unit 135 records the highest video quality evaluation value as a correct video quality evaluation value for each of the frames. In the case where copying or missing of a frame occurs, usually, different frames are compared at the time of comparing an encoded video and an original video, so that the video quality evaluation value largely decreases. On the other hand, according to the video quality evaluation value calculating process, by using the fact that the same frame as the frame in the encoded video is referred to as a frame in any shifted original video, an accurate video quality evaluation value can be calculated even in the case where copying or missing of a frame occurs. In the video quality evaluation value calculating process, various objective video quality indexes classified by the full reference method such as PSNR (Peak Signal-to-Noise Ratio), SSIM (Structural Similarity), or VMAF (Video Multimethod Assessment Fusion) are used for calculation of a video quality evaluation value. The details of the video quality evaluation value calculating process executed by the video quality calculation unit 135 will be described later with reference to FIGS. 4 to 6.

The computation unit 111 may further have the function blocks of a setting change unit 136 and a video quality criterion determination support unit 137 by executing the above-described video encoding parameter design support program 130 by the processor 101.

The setting change unit 136 executes, at least, a process for changing the settings of the video encoder 140 and/or the video decoder 150 each data-communicably connected to the video encoding parameter design support device 100 via a network by a remote operation from the video encoding parameter design support device 100. This process is performed by writing an encoding parameter to be evaluated in a predetermined setting file stored in the storage unit of each of the video encoder 140 and/or the video decoder 150 by a remote operation from the video encoding parameter design support device 100.

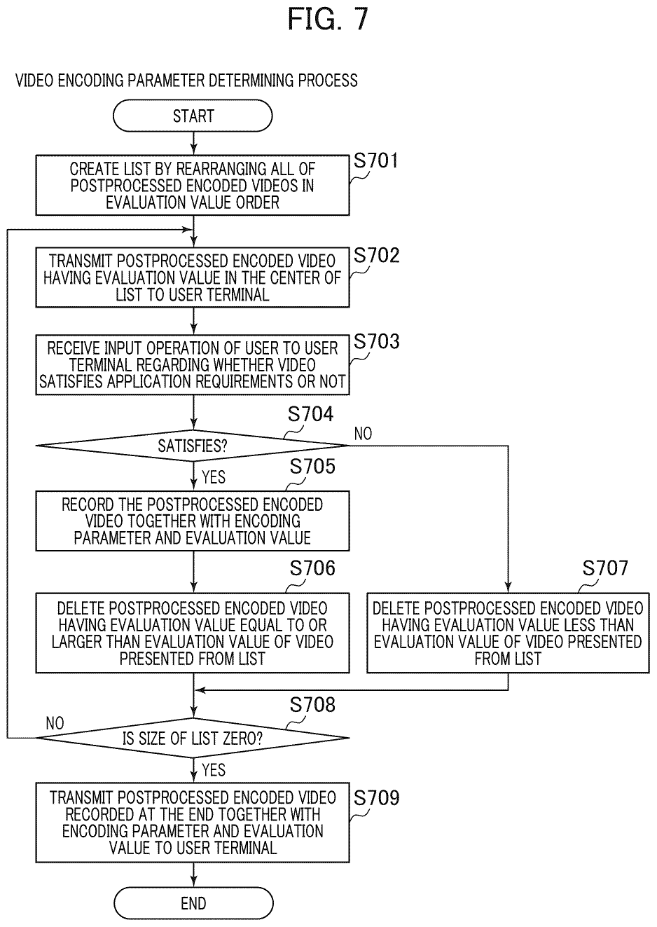

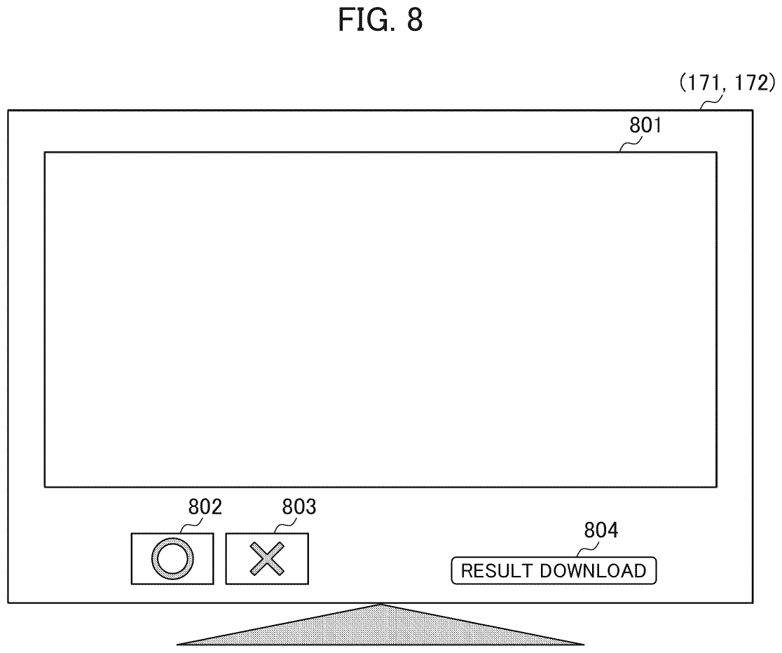

The video quality criterion determination support unit 137 executes, at least, various processes for determining a video encoding parameter satisfying an application requirement (hereinafter, also called “video encoding parameter determination process”) by using a video quality evaluation result which is output from the video quality calculation unit 135 (the details will be described later with reference to FIGS. 7 and 8).

The computation unit 111 is configured by using the processor 101 as a computation device and can realize the function blocks by executing the above-described video encoding parameter design support program 130. The computation unit 111 may be configured by using, for example, a logic circuit such as an FPGA (Field-Programmable Gate Array) or an ASIC (Application Specific Integrated Circuit) in place of the processor 101. For example, the computation unit 111 may be configured by a combination of the processor 101 and a logic circuit.

As described above, the storage unit (112, 113) is configured by including the main storage unit 112 realized by the memory 102 as the main storage device and the auxiliary storage unit 113 realized by the storage 103 as the auxiliary storage device, and stores a program which supplies various process instructions to the computation unit 111 and data expressing various information used in processes executed by the computation unit 111.

The computation unit 111 can execute various processes such as the above-described video quality evaluation value calculating process (which will be described in detail later with reference to FIGS. 4 to 6) and the video encoding parameter determining process (which will be described in detail later with reference to FIGS. 7 and 8) by reading/writing the data expressing the information from/to the storage unit (112, 113).

The communication unit 114 performs processes of communication with other apparatuses, devices, terminals, and the like such as a data server which stores various data, the video encoder 140, the video decoder 150, and the video capture device 160 performed via the network. The communication unit 114 is configured by, for example, using an NIC (Network Interface Card), an HBA (Host Bus Adapter), or the like.

The user interface unit (not illustrated) is configured by including the function blocks of the input unit 115 and the output unit 116.

The input unit 115 handles processes related to input such as reception of an input operation from the user among processes related to the user interface. The input unit 115 is configured by using, for example, the various input devices 105 such as a touch panel, a keyboard, a mouse, and a controller, and detects various operations from the user.

The output unit 116 handles processes related to output such as display on various screens, voice output, and the like to the output device 106 among processes related to the user interface. The output unit 116 is configured by using, for example, various output devices 106 including display devices such as a touch screen and a liquid crystal display.

The mounting of the input unit 115 and/or the output unit 116 is not essential, for example, in the case of performing remote log-in from another external device such as a tablet, a smartphone, a laptop PC, or the like to the video encoding parameter design support device 100 and in the case of receiving input information from the external device and providing output information to the external device via the communication device 104. In this case, by having the function of a web server, the video encoding parameter design support device 100 may receive an access conformed to a predetermined protocol from an external device.

That is, the components of the video encoding parameter design support device 100 are realized by hardware including the processor 101 as the computation device, the storage device such as the memory 102 as the main storage device and the storage 103 as the auxiliary storage device, the interface devices such as the communication device 104, the input device 105, and the output device 106, and the wired or wireless bus connecting those devices, and software stored in the storage device (102, 103) and providing a process instruction to the computation device (the processor 101).

The above-described description related to the functions of the video encoding parameter design support device 100 has been made on assumption that the functions of the video encoding parameter design support device 100 are integrally realized by a single computer. However, the functions may be realized by a plurality of computers and/or servers connected to one another. The video encoding parameter design support device 100 may have a configuration including various portable devices.

In the video encoding parameter design support device 100, the function units such as the video preprocess unit 131, the video output unit 132, the video storage unit 133, the video postprocess unit 134, and the video quality calculation unit 135 may operate, for example, on different physical or logical computers, or may operate on a single physical or logical computer obtained by assembling a plurality of computers.

The description of the functions is an example. A plurality of functions may be combined in a single function, or one function may be divided into a plurality of functions.

The video encoding parameter design support device 100 may have further another function in addition to the above-described functions. For example, the video encoding parameter design support device 100 may be configured in a form including a part or all of the various functions of the external devices such as the video encoder 140, the video decoder 150, the video capture device 160, the user terminal 170, and the like.

### Hardware Configuration Example of External Devices

The hardware configuration of the devices of at least the video encoder 140, the video decoder 150, the video capture device 160, and the user terminal 170 among external devices connected to the video encoding parameter design support device 100 via the network and mutually transmitting/receiving data is similar to that of the video encoding parameter design support device 100 illustrated in FIG. 1.

That is, each of the video encoder 140, the video decoder 150, the video capture device 160, and the user terminal 170 according to the present embodiment is realized by a computer having at least a storage device including a memory and a storage, an interface device including at least a communication device, and a processor connected to those components like the hardware configuration of the video encoding parameter design support device 100 illustrated in FIG. 1. In the external devices (140, 150, 160, and 170), the interface device may include an input device and/or an output device.

The following description will be made on assumption that each of the video encoder 140, the video decoder 150, the video capture device 160, and the user terminal 170 is realized by a single general-purpose computer having one or more processors, one or more memories, one or more storages, one or more communication devices, one or more input devices (for example, the input device 171 of the user terminal 170), one or more output devices (for example, the display device 172 of the user terminal 170), and a wired or wireless communication line connecting the devices.

### Example of Functional Blocks of External Devices

An example of blocks of various functions of those external devices (140, 150, 160, and 170) will now be described. Each of blocks described hereinafter is not a configuration in a hardware unit but is a block in a function unit.

Each of the video encoder 140, the video decoder 150, the video capture device 160, and the user terminal 170 according to the present embodiment is configured by having function blocks of a control unit (not illustrated), a storage unit (not illustrated), a communication unit (not illustrated), and a user interface unit (not illustrated) made by an input unit (not illustrated) and an output unit (not illustrated).

The control unit executes various data processes on the basis of programs and data stored in the storage unit and data obtained by the communication unit. The control unit also functions as an interface of the storage unit and the communication unit.

The control units of the video encoder 140, the video decoder 150, and the video capture device 160 execute, at least, the video encoding parameter designing process depicted in FIG. 5 in cooperation with the computation unit 111 of the video encoding parameter design support device 100 and the control units of other external devices (the details will be described later).

The control unit of the user terminal 170 executes, at least, the video encoding parameter designing process depicted in FIG. 5 and the video encoding parameter determining process depicted in FIG. 7 in cooperation with the computation unit 111 of the video encoding parameter design support device 100 (the details will be described later).

The control unit is configured by using a processor as a control device and can realize each of the function blocks by executing a corresponding program. The control unit may be configured by using, for example, a logic circuit such as an FPGA (Field-Programmable Gate Array) or an ASIC (Application Specific Integrated Circuit) in place of the processor. For example, the control unit may be configured by a combination of a processor and a logic circuit.

The storage unit is configured by including, for example, a main storage unit realized by a memory as a main storage device and an auxiliary storage unit realized by a storage as an auxiliary storage device, and stores a program providing various process instructions to the control unit and data expressing various information used in the process executed by the control unit.

The control unit can execute a corresponding process in the above-described video encoding parameter designing process (which will be described in detail later with reference to FIG. 5), the video encoding parameter determining process (which will be described in detail later with reference to FIGS. 7 and 8), and the like by reading/writing such a program and data from/to the storage unit in cooperation with the computation unit 111 of the video encoding parameter design support device 100.

The communication unit handles a process of communication with the video encoding parameter design support device 100 and other apparatuses and devices, terminals, and the like performed via the network. The communication unit is configured by, for example, using an NIC (Network Interface Card), an HBA (Host Bus Adapter), or the like.

The user interface unit is configured by including the function blocks of the input unit and the output unit.

The input unit handles a process related to an input such as reception of an input operation from the user among processes related to the user interface. The input unit is configured by using, for example, various input devices (for example, the input device 171 of the user terminal 170) such as a touch panel, a keyboard, a mouse, a controller, and the like, and detects various operations from the user.

The output unit handles a process related to output such as display, sound output, and the like of various screens to the display device (for example, the display device 172 of the user terminal 170) among processes related to the user interface. The output unit is configured, for example, by using various output devices including display devices (for example, the display device 172 of the user terminal 170) such as a touch screen and a liquid crystal display.

The mounting of the input unit and/or the output unit to the video encoder 140, the video decoder 150, and/or the video capture device 160 is not necessary, for example, in the case of performing remote log-in from another external device such as the user terminal 170 to the video encoder 140, the video decoder 150, and/or the video capture device 160 or in the case of receiving input information from another terminal and providing output information to another terminal via the communication device. In this case, the video encoder 140, the video decoder 150, and/or the video capture device 160 may receive an access according to a predetermined protocol from an external device by having the function of a web server.

That is, each of the components of the video encoder 140, the video decoder 150, the video capture device 160, and the user terminal 170 is realized by hardware including a processor as a computation device, a storage device such as a memory as a main storage device and a storage as an auxiliary storage device, an interface device such as a communication device, an input device (for example, the input device 171 of the user terminal 170), and an output device (for example, the display device 172 of the user terminal 170), and a wired or wireless bus connecting the devices, and software stored in the storage device and supplying a process instruction to the computation device (processor).

The above description related to the functions of the video encoder 140, the video decoder 150, the video capture device 160, and the user terminal 170 was made on assumption that each of the functions of the external devices (140, 150, 160, and 170) is integrally realized by a single computer. However, the functions may be realized by a plurality of computers and/or servers connected to one another. The external devices (140, 150, 160, and 170) may have a configuration including a general-purpose computer such as a laptop PC and a web browser installed in the computer or a configuration including various portable devices.

The function units of the external devices (140, 150, 160, and 170) may operate on different physical or logical computers or a plurality of them may be combined and operate on a single physical or logical computer.

The description of the functions is an example. A plurality of functions may be combined in a single function, or one function may be divided into a plurality of functions.

The external devices (140, 150, 160, and 170) may have another function in addition to the above-described functions.

### Method Of Calculating Video Quality Evaluation Value

Next, a method used to calculate a video quality evaluation value by the video encoding parameter design support device 100 according to the present embodiment will be described with reference to FIG. 4.

FIG. 4 is a diagram for explaining outline of a method of calculating the video quality evaluation value.

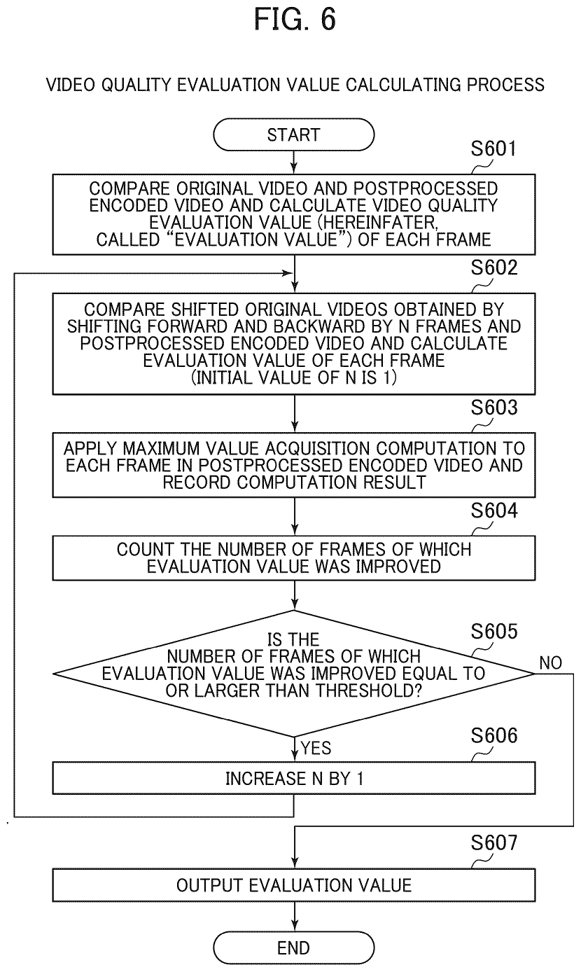

The video encoding parameter design support device 100 calculates a video quality evaluation value by executing the video quality evaluation value calculating process (which will be described in detail with reference to FIGS. 5 and 6) according to the method.

As described above, first, the video encoding parameter design support device 100 performs, as a preprocess, a process of adding positioning frames 401 for specifying the start position and the end position of a video to the original video to be evaluated to create a preprocessed original video. The preprocessed original video created by the video preprocess unit 131 is configured, as illustrated in FIG. 4, by the positioning frames 401 and original video frames 402. The video encoding parameter design support device 100 transmits the created preprocessed original video to the video encoder 140 by the video output unit 132. As illustrated in FIG. 4, the preprocessed original video is transmitted to the video encoder 140, the video decoder 150, and the video capture device 160 in order, and subjected to sequential processes in the components to become an encoded video.

After that, the encoded video is transmitted again to the video encoding parameter design support device 100 by the video capture device 160. The encoded video is configured by, as illustrated in FIG. 4, an unrelated frame 403, an encoded positioning frame 404, and an encoded video frame 405. The video encoding parameter design support device 100 stores an encoded video received from the video capture device 160. The video encoding parameter design support device 100 extracts only the encoded video frame 405 from the stored encoded video by using the encoded positioning frame 404 as a marker expressing an extraction position to create a postprocessed encoded video (not illustrated). The created postprocessed encoded video is compared with the original video and the above-described shifted original videos (videos obtained by shifting the original video backward or forward only by the predetermined number of frames).

FIG. 4 illustrates a case where the third frame in the original video drops during video transfer. In this case, at the time of comparing the encoded video and the original video, the video encoding parameter design support device 100 can compare the same frames until a midway frame but, after occurrence of frame missing, compares different frames as illustrated in FIG. 4. On the other hand, in this case, at the time of comparing the encoded video and the shifted original video (shifted before one frame), the video encoding parameter design support device 100 compares different frames until a midway frame but, after occurrence of frame missing, can compare the same frames.

By aggregating video quality evaluation values of frames calculated for the original video and the shifted original video by a computing process called a maximum value obtaining computation (which will be described in detail later with reference to FIG. 6), the video encoding parameter design support device 100 can compare the same frames with respect to all of the frames of the encoded video.

Except for the case illustrated in FIG. 4, copying of a frame may occur in the encoded video. For example, in the case where copying of one frame occurs in the encoded video, the video encoding parameter design support device 100 compares the corresponding frames by associating a shifted original video obtained by shifting the original video by one frame backward with the encoded video. For example, in the case where missing of one frame occurs in the encoded video, the video encoding parameter design support device 100 compares the corresponding frames by associating a shifted original video obtained by shifting the original video by one frame forward with the encoded video.

The shifted original video may be shifted backward or forward only by the arbitrary number of frames.

### System Operation Example

An example of the operation of the entire system including the video encoding parameter design support device 100 according to the present embodiment will now be described with reference to FIGS. 5 to 7 mainly with respect to the processes executed by the video encoding parameter design support device 100. FIG. 5 is a sequence diagram illustrating an example of the flow of the entire video encoding parameter designing process executed mainly by the video encoding parameter design support device 100. FIG. 6 is a flowchart illustrating an example of the flow of the video quality evaluation value calculating process executed by the video encoding parameter design support device 100 as one step of the video encoding parameter designing process illustrated in FIG. 5. Further, FIG. 7 is a flowchart illustrating an example of the flow of the video encoding parameter determining process executed mainly by the video encoding parameter design support device 100 after completion of the video encoding parameter designing process illustrated in FIG. 5.

### Video Encoding Parameter Determining Process

First, the procedure of designing a video encoding parameter will be described with reference to FIG. 5.

FIG. 5 is a sequence diagram illustrating an example of the flow of the entire video encoding parameter designing process executed mainly by the video encoding parameter design support device 100.

The video capture device 160 is not much related to the video encoding parameter designing process so that it is not illustrated in the sequence diagram of FIG. 5.

In step S501, a control unit (not illustrated) of the user terminal 170 executes a process of receiving an input operation to designate a video encoding parameter desired to be evaluated, performed by the user of the video encoding parameter design support device 100 to the user terminal 170 via an input unit (not illustrated) and registering it in a setting file. As a video encoding parameter which can be registered in the setting file in step S501, for example, there are various parameters which are set at the time of performing an encoding process on a video such as a bit rate, a video output resolution, a video encoding method, chroma subsampling, a quantization parameter, a GOP (Group Of Picture) structure, and the like. The video encoding method is set by a standard of, for example, “H. 264”, “H. 265”, “H. 266”, “VP9”, “AV1”,“MPEG-2”, “MPEG-5”, and the like. The chroma subsampling is set by a type of, for example, “4:4:4”, “4:2:2”, “4:2:0”, or the like. The quantization parameter is a parameter to control the compression degree at the time of compressing information. The GOP structure is a method of difference encoding and is, for example, set by a form such as “only I frame”, “IPPP”, “IBBP”, or the like. The setting file may be also configured so that, for example, a parameter which is not related to the encoding process such as a reception buffer size, device monitoring setting, or the like can be registered. The setting file may be configured so that a plurality of encoding parameters can be registered so that evaluation can be made a plurality of times continuously. By the above, a video encoding parameter designated by the user is registered in the setting file. When the video encoding parameter is registered in the setting file, the control unit of the user terminal 170 transmits an instruction signal to urge activation software that performs video quality evaluation (hereinafter, also simply called “software”) to the video encoding parameter design support device 100. When the instruction signal is received from the user terminal 170 via the communication unit 114, the computation unit 111 of the video encoding parameter design support device 100 advances to step S502.

In step S502, the computation unit 111 of the video encoding parameter design support device 100 executes, as a preprocess, a computing process of shifting a frame as a component of a video backward or forward (hereinafter, also called “frame shift computation”) on an original video to be evaluated by the video preprocess unit 131, and executes a process of creating the above-described shifted original video (the video obtained by shifting the original video backward or forward only by the predetermined number of frames). As a frame shifting method used by the video preprocess unit 131, a method of rewriting a PTS (Presentation Time Stamp) of each frame in the original video in accordance with a frame rate and the frame shift numbers. In such a manner, a shifted original video is created. After completion of the process in step S502, the computation unit 111 of the video encoding parameter design support device 100 advances to step S503.

In S503, the computation unit 111 of the video encoding parameter design support device 100 executes, as a preprocess, a process of adding the positioning frame 401 for specifying the start position and/or the end position of a video to an original video to be evaluated by the video preprocess unit 131 to create the above-described preprocessed original video (the video obtained by adding the positioning frame 401 to the original video). In such a manner, a preprocessed original video is created. After completion of the process in step S503, the computation unit 111 of the video encoding parameter design support device 100 advances to step S504.

In step S504, the computation unit 111 of the video encoding parameter design support device 100 can start a process of changing the setting of the video encoder 140 and/or the video decoder 150 (hereinafter, also called “setting change process”) by reading a setting file by the setting change unit 136 and transmitting a request to change the setting (hereinafter, also called “setting change request”) to the video encoder 140 and/or the video decoder 150 on the basis of the content of the setting file which is read. In the case where the process of transmitting the setting change request to the video encoder 140 and/or the video decoder 150 performed in step S504 is executed by the video encoding parameter design support device 100 different from that performing a video storing process which will be described later, the setting change request may be transmitted to the video encoder 140 and/or the video decoder 150 by receiving a notification regarding the end of the video storing process from the video storage unit 133 of the video encoding parameter design support device 100 in which the video storing process is performed and executing the process of the step by using the notification as a trigger. In such a manner, the setting change process can be started for the video encoder 140 and/or the video decoder 150. A control unit (not illustrated) of the video encoder 140 which receives the setting change request from the video encoding parameter design support device 100 advances to step S505. Similarly, a control unit (not illustrated) of the video decoder 150 which receives the setting change request from the video encoding parameter design support device 100 advances to step S506.

In step S505, the control unit of the video encoder 140 executes the setting change process to change the setting of itself. The video encoder 140 is equipped with an API (Application Interface) for receiving a setting change request from the user terminal 170. In the case where it is difficult to provide such an API, the setting of itself may be changed by a remote operation from the user terminal 170 by using an SSH (Secure Shell), a headless browser, the like. In such a manner, the setting of the video encoder 140 is changed according to the content of the setting change request transmitted in step S504. When the setting of itself is changed, the control unit of the video encoder 140 transmits a response signal expressing end of the setting change process (hereinafter, also called “setting change response”) to the video encoding parameter design support device 100. When the setting change response is received from the video encoder 140 via the communication unit 114, the computation unit 111 of the video encoding parameter design support device 100 advances to step S507.

In step S506, the control unit of the video decoder 150 executes the setting change process to change the Setting of itself. The video decoder 150 is equipped with an API for receiving a setting change request from the user terminal 170. In the case where it is difficult to provide such an API, the setting of itself may be changed by a remote operation from the user terminal 170 by using an SSH, a headless browser, or the like. In such a manner, the setting of the video decoder 150 is changed according to the content of the setting change request transmitted in step S504. The control unit of the video decoder 150 changes the setting of itself and then transmits a setting change response to the video encoding parameter design support device 100. When the setting change response is received from the video decoder 150 via the communication unit 114, the computation unit 111 of the video encoding parameter design support device 100 advances to step S507.

In step S507, the computation unit 111 of the video encoding parameter design support device 100 starts a process of storing the received encoded video by the video storage unit 133 (hereinafter, also called “video storing process”). In the case where the video storing process started in step S507 is executed by the video encoding parameter design support device 100 different from the one which performed the process of transmitting the setting change request to the video encoder 140 and/or the video decoder 150 in step S504, the video storing process may be started by receiving a notification regarding setting completion from the setting change unit 136 of the video encoding parameter design support device 100 as the transmission source of the setting change request and executing the process of the step using the notification as a trigger. By the process, the video storing process is started. After completion of the process in step S507, the computation unit 111 of the video encoding parameter design support device 100 advances to step S508.

In step S508, the computation unit 111 of the video encoding parameter design support device 100 starts a process of reproducing the preprocessed original video created in step S503 (hereinafter, also called “video reproducing process”) by the video output unit 132. In the case where the video reproducing process started in step S508 is executed by the video encoding parameter design support device 100 different from that of the video storing process started in step S507, the video reproducing process may be started by receiving a notification regarding start of the video storing process from the video output unit 132 of the video encoding parameter design support device 100 in which the video storing process is performed and executing the process of the step by using the notification as a trigger. By the process, video reproducing process is started. After completion of the process in step S508, the computation unit 111 of the video encoding parameter design support device 100 advances to step S509. During a period since completion of the process executed in step S508 until start of the process executed in step S509, the preprocessed original video signal is transmitted from the video encoding parameter design support device 100 to the video encoder 140 and an encoded video packet is transmitted from the video encoder 140 to the video decoder 150 and, after that, an encoded video signal is transmitted from the video decoder 150 to the video encoding parameter design support device 100 via the video capture device 160.

In step S509, the computation unit 111 of the video encoding parameter design support device 100 finishes the video storing process which was started in step S508 by the video output unit 132. By the process, video reproducing process is finished. After completion of the process in step S509, the computation unit 111 of the video encoding parameter design support device 100 advances to step S510.

In step S510, the computation unit 111 of the video encoding parameter design support device 100 finishes the video storing process which was started in step S507 by the video storing unit 133. In the case where the video storing process finished in step S510 is executed by the video encoding parameter design support device 100 different from that of the video reproducing process finished in step S509, the video storing process may be finished by receiving a notification regarding the end of the video reproduction from the video output unit 132 of the video encoding parameter design support device 100 in which the video reproducing process is performed and executing the process of the step by using the notification as a trigger. By the process, the video storing process is finished, and the encoded video is stored in an arbitrary file format. After completion of the process in step S510, the computation unit 111 of the video encoding parameter design support device 100 advances to step S511.

In step S511, the computation unit 111 of the video encoding parameter design support device 100 executes a process of creating a postprocessed encoded video as a video obtained by extracting only a video part to be evaluated from the encoded video stored in step S510 by referring to the positioning frame (the encoded positioning frame 404) by the video postprocess unit 134. In the process, for example, in the case of using a monochromatic frame of black as the positioning frame (the encoded positioning frame 404), a black frame is searched from the head of the video, and the position where continuous black frames are interrupted for the first time is set as a start frame of the video to be evaluated.

Similarly, in this case, for example, a black frame is searched from the end of the video, and the position where continuous black frames are interrupted for the first time is set as an end frame of the video to be evaluated. In the case of detecting the positioning frame (the encoded positioning frame 404), the detection is performed in consideration of degradation and color change due to the encoding process. In such a manner, a postprocessed encoded video is created. After completion of the process in step S511, the computation unit 111 of the video encoding parameter design support device 100 advances to step S512.

In step S512, the computation unit 111 of the video encoding parameter design support device 100 executes the above-described video quality evaluation value calculating process (process for calculating the video quality evaluation value) for each of the frames of the postprocessed encoded video by comparing the postprocessed encoded video created in step S511, the original video, and the shifted original video created in step S502 by the video quality calculation unit 135. The details of the video quality evaluation value calculating process will be described later with reference to FIG. 6. In the video quality evaluation value calculating process, the computation unit 111 of the video encoding parameter design support device 100 may calculate, in addition to the video quality evaluation value for each frame, various statistical information such as an average value, a median, dispersion, a standard deviation, a maximum value, and a minimum value for the whole and for each segment. In such a manner, the video quality evaluation value is calculated. The computation unit 111 of the video encoding parameter design support device 100 repeats the processes of steps S504 to S512 only by the number of encoding parameters to be evaluated. After that, the computation unit 111 of the video encoding parameter design support device 100 transmits the postprocessed encoded video, the video encoding parameter, and the video quality evaluation result to the user terminal 170. The control unit of the user terminal 170 receives the postprocessed encoded video, the video encoding parameter, and the video quality evaluation result from the video encoding parameter design support device 100 and advances to step S513.

In step S513, the control unit of the user terminal 170 executes a process of designing a video encoding parameter satisfying an application requirement by efficiently referring to the postprocessed encoded video on the basis of the video quality evaluation result. By the process, a video encoding parameter satisfying the application requirement is designed. After completion of the process in step S513, the control unit of the user terminal 170 finishes the processes depicted in the sequence diagram of FIG. 5.

### Video Quality Evaluation Value Calculating Process

A procedure of calculating a video quality evaluation value will now be described with reference to FIG. 6.

FIG. 6 is a flowchart specifically illustrating an example of the flow of the video quality evaluation value calculating process executed by the video encoding parameter design support device 100 in step S512 in FIG. 5.

In step S601, the computation unit 111 of the video encoding parameter design support device 100 executes a process of calculating the video quality evaluation value for each of the frames of the postprocessed encoded video by comparing corresponding frames in the original video and the postprocessed encoded video by the video quality calculation unit 135. A frame in the original video and a frame in the postprocessed encoded video are associated by a method of “associating frames having the same index”, a method of “making a frame in the original video displayed in a PTS in the postprocessed encoded video associated by referring to the PTS”, or the like. In such a manner, the video quality evaluation value is calculated for each of frames of the postprocessed encoded video. After completion of the process in step S601, the computation unit 111 of the video encoding parameter design support device 100 advances to step S602.

In step S602, the computation unit 111 of the video encoding parameter design support device 100 executes a process of calculating a video quality evaluation value for each of the frames of the postprocessed encoded video by comparing corresponding frames in shifted original videos obtained by shifting the original video by N frames backward or forward and the postprocessed encoded video by the video quality calculation unit 135. The default value of N is 1. A frame in the shifted original video and a frame in the postprocessed encoded video are associated by a method similar to that in step S601. In the case where shifted original videos obtained by shifting the original video backward or forward by N frames are not created in advance, they may be created in step S602. In such a manner, the video quality evaluation value is calculated for each of frames of the postprocessed encoded video. After completion of the process in step S602, the computation unit 111 of the video encoding parameter design support device 100 advances to step S603.

In step S603, the computation unit 111 of the video encoding parameter design support device 100 executes a computation process of recording, as a correct value, the maximum value in a plurality of video quality evaluation values (hereinafter, also called “maximum value acquisition computation”) for each of the frames of the postprocessed encoded video calculated in steps S601 and S602 by the video quality calculation unit 135. By the process, for each of the frames of the postprocessed encoded video calculated in steps S601 and S602, the maximum value of the plurality of video quality evaluation values is recorded as a correct value. After completion of the process in step S603, the computation unit 111 of the video encoding parameter design support device 100 advances to step S604.

In step S604, the computation unit 111 of the video encoding parameter design support device 100 executes a process of counting the number of frames whose video quality evaluation value is improved from an immediately preceding loop for the result of the maximum value acquisition computation executed in step S603 by the video quality calculation unit 135. With respect to the first loop, the number of frames whose video quality evaluation value is improved is counted for each of the frames of the postprocessed encoded video calculated in step S601. In such a manner, the number of frames whose video quality evaluation value is improved is counted. After completion of the process in step S604, the computation unit 111 of the video encoding parameter design support device 100 advances to step S605.

In step S605, the computation unit 111 of the video encoding parameter design support device 100 executes a process of determining whether the number of frames counted (whose video quality evaluation value is improved) in step S604 is equal to or larger than a threshold by the video quality calculation unit 135. The threshold used in this step is a value to adjust a range in which the influence of copying or missing of a frame is considered. For example, in the case of setting the threshold to 1, the computation unit 111 of the video encoding parameter design support device 100 repeatedly executes the processes in steps S602 to S604 until the influence of copying or missing is eliminated for all of the frames by the video quality calculation unit 135. The video quality calculation unit 135 may calculate the ratio of the number of frames whose video quality evaluation value is improved and use it as a threshold, not the number of frames whose video quality evaluation value is improved. The computation unit 111 of the video encoding parameter design support device 100 may calculate statistical information such as an average value, a median, dispersion, a standard deviation, a maximum value, and a minimum value of video quality evaluation values of the entire video in addition to the video quality evaluation value, and execute the determination process in this step by using the statistical information. When it is determined that the number of frames is equal to or larger than the threshold (Yes in step S605), the computation unit 111 advances to step S606 to increase N by one. On the other hand, when it is determined that the number of frames is less than the threshold (No in step S605), the computation unit 111 advances to step S607.

In step S606, the computation unit 111 of the video encoding parameter design support device 100 executes the process of increasing N by one to enlarge the shift range to be considered by the video quality calculation unit 135. By the process, <> is performed. After completion of the process in step S606, the computation unit 111 of the video encoding parameter design support device 100 advances to step S607.

In step S607, the computation unit 111 of the video encoding parameter design support device 100 executes a process of outputting the video quality evaluation value recorded last in step S603 by the video quality calculation unit 135. By the process, the video quality evaluation value is output. After completion of the process in step S607, the computation unit 111 of the video encoding parameter design support device 100 finishes the video quality evaluation value calculating process of the flowchart of FIG. 6.

As described above, in the video quality evaluation value calculating process executed in step S512 in FIG. 5, as illustrated in the flowchart of FIG. 6, a plurality of video quality evaluation values are calculated by comparing the postprocessed encoded video, the original video, and the shifted original video (steps S601 to S602 in FIG. 6), and the plurality of video quality evaluation values calculated are aggregated by the maximum value acquisition computation (step S604 in FIG. 6). By calculating the video quality evaluation value by such a procedure, the video encoding parameter design support device 100 can calculate an accurate video quality evaluation value in which copying and missing of a frame is considered.

### Video Encoding Parameter Determining Process

A procedure of determining a video encoding parameter will now be described with reference to FIG. 7.

FIG. 7 is a flowchart illustrating an example of the flow of a video encoding parameter determining process executed by the video encoding parameter design support device 100. The video encoding parameter determining process is executed mainly by the video encoding parameter design support device 100 after completion of the video encoding parameter design process illustrated in the sequence diagram of FIG. 5.

In step S701, the computation unit 111 of the video encoding parameter design support device 100 executes a process of creating a list by rearranging all of the postprocessed encoded videos in the order of the video quality evaluation value by the video quality criterion determination support unit 137. As the video quality evaluation value, an average value, a median, a lowest value, or the like of the entire video is used. By the process, a list in which all of the postprocessed encoded videos are arranged in the order the video quality evaluation value (hereinafter, also simply called “list”) is created. After completion of the process in step S701, the computation unit 111 of the video encoding parameter design support device 100 advances to step S702.

In step S702, the computation unit 111 of the video encoding parameter design support device 100 executes a process of transmitting a postprocessed encoded video having a video quality evaluation value which is in the center in the list generated in step S701 by the video quality criterion determination support unit 137 to the user terminal 170 via the communication unit 114. In the case where there are a plurality of postprocessed encoded videos having the video quality evaluation value in the center of the list, one video is selected at random and transmitted to the user terminal 170. When the postprocessed encoded video is received via the communication unit, the control unit of the user terminal 170 displays them in the display device 172. By the process, the postprocessed encoded video is displayed on the display device 172 of the user terminal 170, and presented to the user of the video encoding parameter design support device 100 having the user terminal 170. After completion of the process in step S702, the control unit of the user terminal 170 advances to step S703.

In step S703, the control unit of the user terminal 170 executes a process of receiving an input operation regarding whether the postprocessed encoded video presented as a result of the process of step S702 is a video satisfying an application requirement from the user of the video encoding parameter design support device 100 having the user terminal 170. In the process, for example, the control unit of the user terminal 170 receives the input operation from the user via a video encoding parameter determination support screen illustrated in FIG. 8. The video encoding parameter determination support screen is a GUI (Graphical User Interface) display screen displayed on the display device 172 and is configured mainly by a video display area 801, an OK button 802, an unsatisfactory button 803, and a result download button 804. The postprocessed encoded video is displayed in the video display area 801. The user views a screen picture which is displayed in this area and answers regarding whether the application requirement is satisfied or not by using the OK button 802 and the unsatisfactory button 803. When the input operation is received via the input device 171, the control unit of the user terminal 170 transmits the content to the video encoding parameter design support device 100 via the communication unit. In such a manner, the input content by the user regarding whether the video is a video satisfying the application requirement or not is obtained. After completion of the process in step S703, the computation unit 111 of the video encoding parameter design support device 100 advances to step S704.

In step S704, the computation unit 111 of the video encoding parameter design support device 100 executes a process of determining whether or not the postprocessed encoded video presented to the user in step S702 satisfies the application requirement on the basis of the input content of the user obtained in step S703 by the video quality criterion determination support unit 137. When it is determined that the postprocessed encoded video satisfies the application requirement (Yes in step S704), the postprocessed encoded video is recorded together with the encoding parameter and the video quality evaluation value (step S705). After that, to eliminate the postprocessed encoded video having the video quality evaluation value equal to or larger than that of the postprocessed encoded video from the list (step S706), the computation unit 111 advances to step S705. On the other hand, when it is determined that the postprocessed encoded video does not satisfy the application requirement (No in step S704), the computation unit 111 advances to step S707 to eliminate the postprocessed encoded video having a video quality evaluation value lower than that of the postprocessed encoded video.

In step S705, the computation unit 111 of the video encoding parameter design support device 100 executes a process of recording the postprocessed encoded video presented to the user in step S702 together with the encoding parameter and the video quality evaluation value by the video quality criterion determination support unit 137. In the case where there are a plurality of postprocessed encoded videos having an equivalent video quality evaluation value in step S702, all of them may be recorded. By the above process, the postprocessed encoded video is recorded together with the encoding parameter and the video quality evaluation value. After completion of the process in step S705, the computation unit 111 of the video encoding parameter design support device 100 advances to step S706.

In step S706, the computation unit 111 of the video encoding parameter design support device 100 executes a process of eliminating the postprocessed encoded video having a video quality evaluation value more than that of the postprocessed encoded video presented to the user in step S702 from the list by the video quality criterion determination support unit 137. By the process, the postprocessed encoded video having the video quality evaluation value equal to or higher than that of the postprocessed encoded video is eliminated from the list, and a search range in the following loop is narrowed. After completion of the process in step S706, the computation unit 111 of the video encoding parameter design support device 100 advances to step S708.

In step S707, the computation unit 111 of the video encoding parameter design support device 100 executes a process of eliminating the postprocessed encoded video having a video quality evaluation value less than that of the postprocessed encoded video presented to the user in step S702 from the list by the video quality criterion determination support unit 137. By the process, the postprocessed encoded video having the video quality evaluation value less than that of the postprocessed encoded video is eliminated from the list, and the search range in the following loop is narrowed. After completion of the process in step S707, the computation unit 111 of the video encoding parameter design support device 100 advances to step S708.

In step S708, the computation unit 111 of the video encoding parameter design support device 100 executes a process of determining whether the size of the list is zero or not by the video quality criterion determination support unit 137. A concrete determination criterion in the process of step S708 may be whether the file size of the list is zero byte or not. In the case where the list is recorded in a table format, a concrete determination criterion may be whether the number of rows in a record in the list is zero not. In the case where it is determined that the size of the list is zero (Yes in step S708), since search of the reference value of the video quality evaluation value satisfying the application requirement is completed, the computation unit 111 advances to step S709 to notify the user of the postprocessed encoded video recorded last in step S705 together with the encoding parameter and the video quality evaluation value. On the other hand, in the case where it is determined that the size of the list is not zero (No in step S708), search for the criterion value of the video quality evaluation value satisfying the application requirement has not been completed, so that the computation unit 111 returns again to step S702 to continue the video encoding parameter determining process in the flowchart of FIG. 7. By repeating the series of processes of steps S702 to S708 a plurality of times, the video encoding parameter design support device 100 can narrow down video quality criterion values satisfying the application requirement. Based on the video quality criterion value, the video encoding parameter design support device 100 can also determine an encoding parameter having highest communication efficiency achieving the video quality criterion value. The worst calculation amount at this time is O (log n) with respect to the number of encoding parameters. Videos for all of encoding parameters can be efficiently searched more than viewing the videos by humans.

In step S709, the computation unit 111 of the video encoding parameter design support device 100 executes a process of transmitting the postprocessed encoded video recorded last in step S705 together with the encoding parameter and the video quality evaluation value to the user terminal 170 held by the user by the video quality criterion determination support unit 137. When the postprocessed encoded video is received together with the encoding parameter and the video quality evaluation value via the communication unit, the control unit of the user terminal 170 displays them in the display device 172. By the process, the postprocessed encoded video is displayed together with the encoding parameter and the video quality evaluation value in the display device 172 of the user terminal 170 and presented to the user. After completion of the process in step S709, the control unit of the user terminal 170 finishes the video encoding parameter determining process illustrated in the flowchart of FIG. 7. The end of the video encoding parameter determining process is notified to the user, for example, by a popup or the like displayed in the video display area 801 in the video encoding parameter determination support screen.

As described above, in the video encoding parameter determining process executed after completion of the video encoding parameter designing process depicted in the Sequence diagram of FIG. 5, as illustrated in the flowchart of FIG. 7, the video quality criterion determination support unit 137 displays one or more postprocessed encoded videos output from the video postprocess unit 134 in the user terminal 170 and, on the basis of the input content of whether the application requirement is satisfied or not for each of the postprocessed encoded videos received from the user of the video encoding parameter design support device 100 having the user terminal 170, determines an encoding parameter satisfying the application requirement and having most preferable communication efficiency. That is, in the video encoding parameter determining process, by reference to the video quality evaluation results evaluated by various encoding parameters, the postprocessed encoded video is presented to the user and evaluated (steps S701 to S708 in FIG. 7).

By determining the video encoding parameter by such a procedure, the video encoding parameter design support device 100 can determine a criterion value of the video quality evaluation value satisfying the application requirement and the video encoding parameter satisfying it for the postprocessed encoded video.

The video encoding parameter design support device 100 according to the present embodiment has been described above.

The embodiments of the present invention described above are summarized as follows.

(1) The video encoding parameter design support device 100 is a device for supporting designing of a parameter of the video encoder 140 and is made by a computer having at least the processor 101 and the memory 102. The processor 101 creates one or more shifted original videos by shifting an original video backward or forward by a predetermined number of frames by the video preprocess unit 131 and, by the video quality calculation unit 135, makes videos in each set correspond to each other on a frame unit basis by aligning process start positions in each set with respect to each of a set of an encoded video obtained by encoding the original video and the original video and a set of the encoded video and the shifted original video, calculates an index based on similarity in each set with respect to a set of a frame in the encoded video and a corresponding frame in the original video and a set of a frame in the encoded video and a corresponding frame in the shifted original video, and sets the largest one in indexes calculated with respect to each of the frames in the encoded video as a video quality evaluation value of the frame. In such a manner, even in the environment having the possibility that copying or missing occurs in a part of video frames, the video encoding parameter design support device 100 can automatically calculate an accurate video quality evaluation value. As a result, the video encoding parameter design support device 100 can automatically design a video encoding parameter which is given to the hardware video encoder without manpower so that the communication efficiency becomes the most preferable value while satisfying an application requirement.

(2) An original video has the positioning frames 401 for detecting the start and end positions of a process at the head and the end of a video. The video quality calculation unit 135 aligns the start positions of processes on the basis of the positioning frames (401 and 404) of videos for each of a set of an encoded video and an original video and a set of an encoded video and a shifted original video.

(3) In the process of calculating the video quality, the video quality calculation unit 135 calculates the number of frames whose video quality evaluation value of an encoded video is improved each time the number of shifting a frame in a shifted original video is increased and, when the number of frames becomes below a predetermined threshold, finishes the process of calculating the video quality.

The present invention is not limited to the foregoing embodiments but can be carried out by using an arbitrary component without departing from the gist.

The foregoing embodiment and modification are examples. The present invention is not limited to the above unless otherwise the characteristics of the invention are not impaired. Although the various embodiments and modifications have been described above, the present invention is not limited to them. The scope of the present invention includes other modes which can be considered within the scope of the technical ideas of the present invention.

In the above-described drawings, control lines and information lines which are considered to be necessary in the description are illustrated. All of control lines and information lines mounted are not always illustrated. For example, it may be regarded that almost all of components are connected mutually in practice.

The arrangement of the function units of the video encoding parameter design support device 100 described above is an example. The arrangement of the function units can be changed to an optimum arrangement from the viewpoints such as the performance, process efficiency, and communication efficiency of hardware and software of the video encoding parameter design support device 100.

A part or all of the above-described configurations, functions, process units, process means, and the like may be realized by hardware by, for example, designing them by an integrated circuit, or may be realized by software by interpretating and executing a program realizing each of the functions by the processor 101 as a computation device.

1. A video encoding parameter design support device for supporting designing of a parameter of a video encoder, which is made by a computer comprising at least a processor and a memory, wherein
the processor
creates one or more shifted original videos obtained by shifting an original video backward or forward by a predetermined number of frames
by a video preprocess unit and,
by a video quality calculation unit,
makes videos in each set correspond to each other on a frame unit basis by aligning process start positions with respect to each of a set of an encoded video obtained by encoding the original video and the original video and a set of the encoded video and the shifted original video,
calculates an index based on similarity of a set with respect to each of a set of a frame in the encoded video and a corresponding frame in the original video and a set of a frame in the encoded video and a corresponding frame in the shifted original video, and
sets the largest one in the indexes calculated with respect to each of the frames in the encoded video as a video quality evaluation value of the frame.

2. The video encoding parameter design support device according to claim 1, wherein
the original video has positioning frames for detecting start and end positions of a process at the head and the end of the video, and
the video quality calculation unit aligns the start positions of processes on the basis of the positioning frames of videos with respect to each of a set of the encoded video and the original video and a set of the encoded video and the shifted original video.

3. The video encoding parameter design support device according to claim 1, wherein
the video quality calculation unit calculates, in a process of calculating video quality, the number of frames whose video quality evaluation value is improved in the encoded video each time the number of shifting a frame in the shifted original video is increased and, in the case where the number of frames becomes lower than a predetermined threshold, finishes the process of calculating the video quality.

4. A video encoding parameter design support method for supporting designing of a parameter of a video encoder, in a computer comprising at least a processor and a memory, wherein
the processor
creates one or more shifted original videos obtained by shifting an original video backward or forward by a predetermined number of frames
by a video preprocess unit, and
a video quality calculation unit
makes videos in each set correspond to each other on a frame unit basis by aligning process start positions for each of a set of an encoded video obtained by encoding the original video and the original video and a set of the encoded video and the shifted original video,
calculates an index based on similarity in a set with respect to each of a set of a frame in the encoded video and a corresponding frame in the original video and a set of a frame in the encoded video and a corresponding frame in the shifted original video, and
sets the largest one in the indexes calculated with respect to each of the frames in the encoded video as a video quality evaluation value of the frame.
